(19) United States
(12) Patent Application Publication
(10) Pub. No.: US 2009/0158585 A1
(43) Pub. Date: Jun. 25, 2009

(54) METHOD OF MANUFACTURING LEAD BLOCK FOR ROTARY CONNECTOR

(76) Inventor: Koichi Yajima, Miyagi-ken (JP)

Correspondence Address: BRINKS HOFER GILSON & LIONE, P.O. BOX 10395, CHICAGO, IL, 60610, US

(21) Appl. No.: 12/329,198

(22) Filed: Dec. 5, 2008

(30) Foreign Application Priority Data
Dec. 25, 2007 (JP) 2007-332620

(51) Int. Cl. H01R 43/16

(52) U.S. Cl. 29/874; 29/884; 439/66

(57) ABSTRACT

There is provided a method of manufacturing a lead block for a rotary connector. The rotary connector includes stationary and movable housings, a flexible cable, and lead blocks. The method includes forming a connection terminal connecting body, where connection terminals are connected to each other by connection parts, by performing blanking and bending on a metal plate, forming a base body made of an insulating resin by performing insert molding so that the connection terminal connecting body is embedded in the base body except for at least of the connection parts and first and second connection terminal portions, and making the connection terminals be electrically isolated from each other by removing predetermined portions of the connection parts. The second connection terminal portions of the connection terminals are arranged on parallel planes.

### CLAIM OF PRIORITY

The present invention claims the benefit of and contains subject matter related to Japanese Patent Application No. 2007-332620 filed in the Japanese Patent Office on Dec. 25, 2007, the entire contents of which is incorporated herein by reference.

### BACKGROUND

1. Technical Field

The present invention relates to a method of manufacturing a lead block for a rotary connector assembled into a rotary connector that is assembled in a steering device for a vehicle and electrically connects an electrical device disposed on a stator with an electrical device disposed on a rotor.

2. Related Art

This kind of rotary connector mainly includes stationary and movable housings that are disposed concentrically with each other and connected to each other so as to freely rotate relative to each other, a flexible cable that is received in a space formed between the pair of housings, and lead blocks that are mounted at predetermined positions on the housings. When the movable housing is rotated in a clockwise or counterclockwise direction, the flexible cable is wound or unwound in the space.

The lead block in the related art is a block where a plurality of band-shaped metal pieces (terminal group) formed in a predetermined shape is held by an insulating base body, and each of the band-shaped metal pieces includes a first terminal connected to a conductor part of the flexible cable and a second terminal connected to an external connector or an external lead. That is, one end of the flexible cable is connected to a first terminal of the lead block mounted on the stationary housing, and the other end of the flexible cable is connected a first terminal portion of the lead block mounted on the movable housing. Further, a second terminal of each of the lead blocks is connected to an external connector or an external lead that is led from an external circuit.

The stationary housing is fixed to a steering column of a steering device, the movable housing is fixed to a steering wheel, and an external connector or an external lead is connected to the lead block mounted on each of the housings. Accordingly, the rotary connector having the above-mentioned schematic structure can electrically connect an electrical device disposed on a vehicle body with an electrical device disposed on the steering wheel. Therefore, the rotary connector is used as an electric connection means for, for example, an airbag system or a horn circuit.

Meanwhile, as a steering device of a vehicle has had multiple functions in recent years, the number of circuits tends to increase. However, if the number of circuits increases, a longitudinal dimension excessively increases in the case of a lead block where connection terminal groups used for the connection of an external connector or an external lead are arranged in one line, which causes interference in mounting the lead block on the housing.

In the past, in order to make a lead block compact, there has been proposed a lead block where a plurality of connection terminals (terminal group) for connecting an external connector is arranged in two lines by combining and integrating a plurality of small independent lead blocks (for example, see U.S. Pat. No. 6,733,300 which corresponds to Japanese Unexamined Patent Application Publication No. 2003-45598). Further, as another related art arrangement, there has been proposed a lead block where a connection terminal group for connecting an external connector is arranged in two lines by dividing the lead block into a body part and an extension part, bending a predetermined band-shaped metal piece (extended conductor part) for connecting the body part with the extension part in a U shape, and laminating the extension part on the body part (for example, see U.S. Pat. No. 6,354,853 which corresponds to Japanese Unexamined Patent Application Publication No. 2000-323253).

As described in U.S. Pat. No. 6,733,300, in the case of the lead block where the plurality of small lead blocks is combined and integrated, insert molding, which molds an insulating base body while the terminal group is inserted into a mold, should be performed on each of the small lead blocks. In addition, terminals of the small lead blocks should be connected to each other by ultrasonic welding or the like. Accordingly, there are problems in that the numbers of processes for manufacturing a desired lead block increases and the cost of a mold increases.

Meanwhile, as described in U.S. Pat. No. 6,733,300, in the case of the lead block where the body part and the extension part are connected to each other by the band-shaped metal piece that is bent in a U shape, it is possible to collectively perform the insert molding of the body part and the extension part but it is not easy to bent the band-shaped metal piece in a U shape after the insert molding and to accurately dispose the extension part at a predetermined position on the body part. For this reason, there have been problems in the bending is troublesome and it is difficult to position the connection terminal group of the lead block with high accuracy.

### SUMMARY

A method is disclosed for manufacturing a lead block for a rotary connector. The rotary connector includes stationary and movable housings that are disposed concentrically with each other and connected to each other so as to freely rotate relative to each other, a flexible cable that is received in a space formed between the pair of housings so as to be wound and unwound, and lead blocks that are mounted at predetermined positions on the housings, the lead block being formed of a block where a plurality of connection terminals is held by an insulating base body, and a group of the connection terminals including first connection terminal portions connected to conductor parts of the flexible cable and second connection terminal portions connected to an external connector and/or an external lead. The method includes forming a connection terminal connecting body, where the connection terminals are connected to each other by connection parts, by performing blanking and bending on a metal plate, forming a base body made of an insulating resin by performing insert molding so that the connection terminal connecting body is embedded in the base body except for at least of connection parts and the first and second connection terminal portions, and making the connection terminals be electrically isolated from each other by removing predetermined portions of the connection parts.

In this way, the connection terminal connecting body, which includes the group of the connection terminals and the connection parts, is previously formed. The group of the connection terminals has a predetermined shape where the second connection terminal portions are arranged on parallel planes. The connection terminals are connected to each other by the connection parts. Accordingly, after the base body made of an insulating resin is molded while the connection terminal connecting body is inserted into a mold, desired lead blocks can be manufactured only by removing predetermined portions from the connection parts. The lead block obtained in this way has high dimensional accuracy and is easily made compact since the second connection terminal portions are arranged on parallel planes. Further, since the number of processes is small and the number of parts is reduced as much as possible, it is possible to manufacture a lead block at low cost.

### BRIEF DESCRIPTION OF THE DRAWINGS

FIG. 1 is a plan view of a rotary connector including a lead block for a rotary connector according to a first embodiment of the invention.

FIG. 2 is a perspective view of the lead block shown in FIG. 1.

FIG. 3 is a perspective view of a connection terminal group of the lead block shown in FIG. 2.

FIG. 4 is a view illustrating a process for manufacturing the lead block according to the first embodiment.

FIG. 5 is a view illustrating a process for manufacturing the lead block according to the first embodiment.

FIG. 6 is a view illustrating a process for manufacturing the lead block according to the first embodiment.

FIG. 7 is a front view of the complete lead block in the view illustrating a process for manufacturing the lead block according to the first embodiment.

FIG. 8 is a view illustrating a process for manufacturing a lead block according to a second embodiment of the invention.

FIG. 9 is a view illustrating a process for manufacturing the lead block according to the second embodiment.

FIG. 10 is a view illustrating a process for manufacturing the lead block according to the second embodiment.

FIG. 11 is a front view of the complete lead block in the view illustrating a process for manufacturing the lead block according to the second embodiment.

### DESCRIPTION OF EXEMPLARY EMBODIMENTS

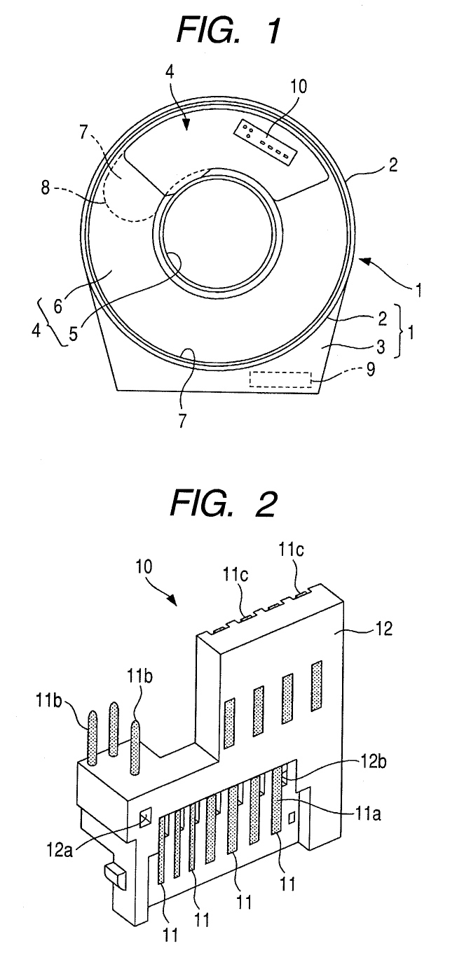

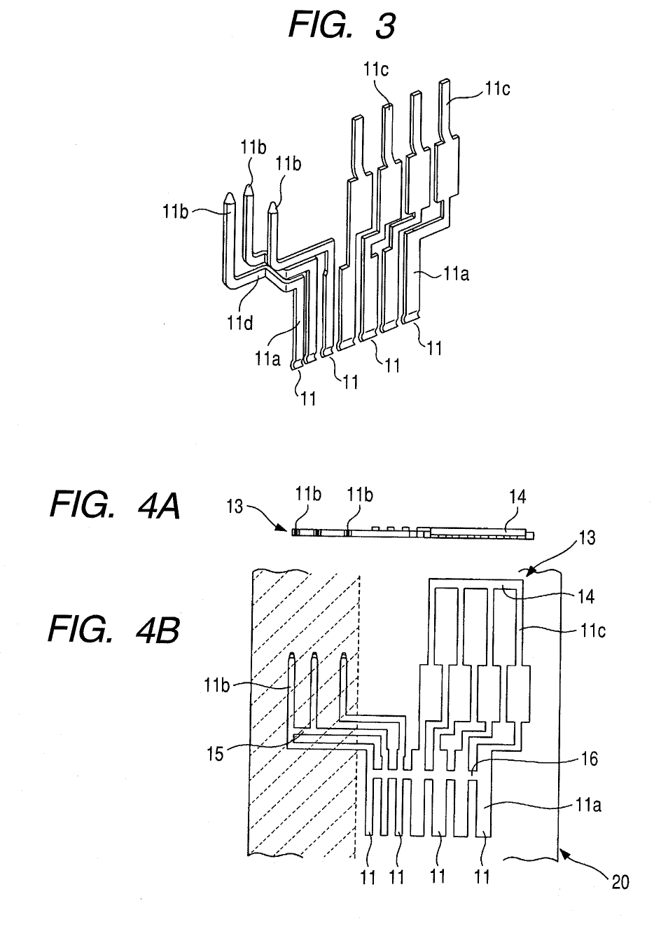

Embodiments of the invention will be described with reference to drawings. FIG. 1 is a plan view of a rotary connector including a lead block for a rotary connector according to a first embodiment of the invention. FIG. 2 is a perspective view of the lead block shown in FIG. 1. FIG. 3 is a perspective view of connection terminals of the lead block shown in FIG. 2. FIGS. 4 to 7 are views illustrating processes for manufacturing the lead block shown in FIG. 2.

As shown in FIG. 1, a rotary connector, which includes a lead block for a rotary connector according to this embodiment, mainly includes a stationary housing 1 that includes an outer cylindrical part 2 and a bottom wall 3, a movable housing 4 that includes an inner cylindrical part 5 and a top plate 6, a flexible cable 8 that is received in an annular space 7 formed between the housings 1 and 4 so as to be wound and unwound, a movable body (not shown) that is disposed in the space 7 so as to be moved in a circumferential direction and winds or unwinds the flexible cable 8, a lead block 9 that is mounted on the stationary housing 1, and a lead block 10 that is mounted on the top plate 6 of the movable housing 4.

The stationary housing 1 and the movable housing 4 are disposed concentrically with each other, and are connected to each other so as to freely rotate relative to each other. The flexible cable 8 is formed in the shape of a band by laminating a plurality of lead wires (conductor parts), which is arranged parallel to each other, on two insulating films. Meanwhile, the conductor parts are exposed to the outside at both ends of the flexible cable 8, one end thereof is connected to the lead block 9 of the stationary housing 1, and the other end thereof is connected to the lead block 10 of the movable housing 4. Since the structure of the lead block 9 is basically the same as that of the lead block 10, only the lead block 10 mounted on the movable housing 4 will be described.

The lead block 10 is a block where a plurality of (seven in this embodiment) connection terminals 11 (a group of connection terminals 11) formed in a predetermined shape is held by an insulating base body 12 as shown in FIG. 2, and has the appearance shown in FIG. 2. The group of the connection terminals 11 is formed by inserting a lead blank (connection terminal connecting body) 13 of FIG. 6 to be described below into a mold, performing molding so that the group of the connection terminals are embedded in a base body made of an insulating resin, and removing connection parts 14 to 16 by blanking or the like. A base body 12 made of an insulating resin is molded in the lead block 10 while the lead blank 13 is inserted into the mold. Further, as shown in FIG. 3, a first connection terminal portion 11a that is connected to the conductor part of the flexible cable 8, a pin-shaped second connection terminal portion 11b that is connected to an external connector (not shown), and a second connection terminal portion 11c that is connected to an external lead (not shown) are formed at each of the connection terminals 11.

Next, a method of manufacturing the lead block 10 will be described with reference to FIGS. 4 to 7. FIGS. 4A, 5A, and 6A are plan views, and FIGS. 4B, 5B, 6B, and 7 are front views. Meanwhile, since a method of manufacturing the lead block 9 is basically the same as the method of manufacturing the lead block 10, the description thereof will be omitted.

First, the lead blank 13, which has the shape of a substantially flat plate, is formed by performing plating on one side portion (hatched portion) of a metal plate 20 as shown in FIG. 4B that is wound in the shape of a coil, and performing blanking (punching) on the metal plate 20. The lead blank 13 may be classified into seven connection terminals 11 and the connection parts 14 to 16, one end of each of the connection terminals 11 forms a first connection terminal portion 11a, and the other ends of the connection terminals form second connection terminal portions 11b and 11c. Further, the first connection terminal portions 11a of the connection terminals 11 are connected to each other by the connection part 16. Two pin-shaped second connection terminal portions, which are shown on the left side of FIG. 4, of the three pin-shaped second connection terminal portions 11b are connected to each other by the connection part 15. Residual four second connection terminal portions 11c are connected to each other by the connection part 14. Meanwhile, the three pin-shaped second connection terminal portions 11b are formed at the plated portion of the metal plate 20. Further, in the manufacturing process shown in FIG. 4, bending is not performed on the two connection terminal portions 11 that are shown on the left side of FIG. 4 and connected to each other by the connection part 15. Accordingly, the group of the connection terminals 11 does not yet have a three-dimensional shape shown in FIG. 3.

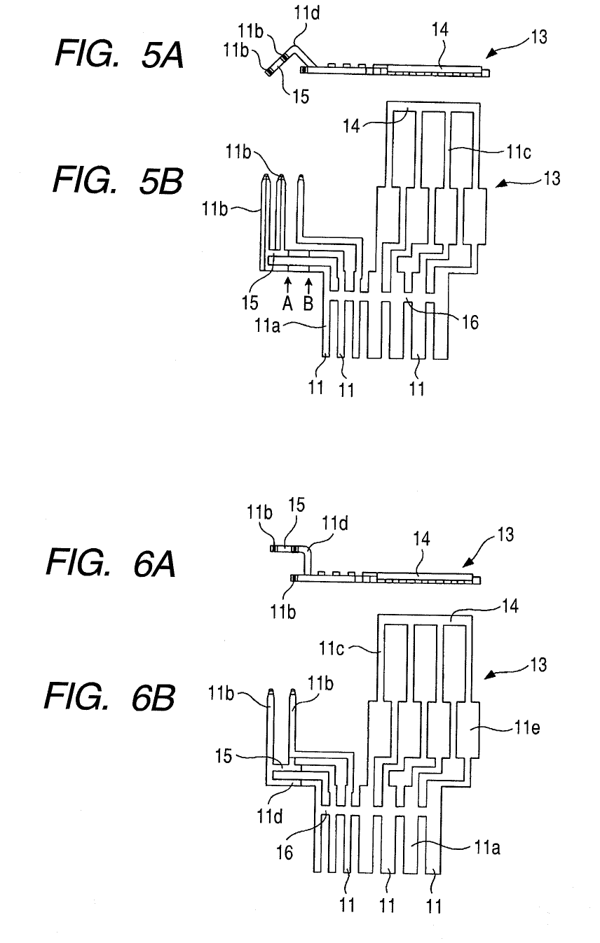

Next, as shown in FIG. 5A, primary bending is performed near the connection part 15 (at positions indicated in FIG. 5A by arrows A and B) on the two connection terminals 11 that are shown on the left side of FIG. 5A and have the second connection terminal portions 11b. Further, as shown in FIG. 6A, the lead blank 13 is formed in a three-dimensional shape by performing secondary bending. That is, L-shaped portions 11d, which are bent in a plate-thickness direction, are formed by the primary bending near the connection part 15 on the two connection terminals 11 (at the positions indicated in FIG. 6A by arrows A and B). Then, the two second connection terminal portions lib and the residual second connection terminal portion 11b are arranged in two lines on parallel planes by the secondary bending. Meanwhile, the dimension and shape of each of the second connection terminal portions 11b shown in FIG. 4B are set so that the three second connection terminal portions 11b are arranged in two lines on a parallel plane by the primary and secondary bending and the tips of the second connection terminal portions have the same height. In order to arrange the plurality of second connection terminal portions 11b on the parallel planes as described above, the dimension and shape of the connection terminal connecting body 13, which has the shape of a flat plate and is shown in FIG. 4B, are appropriately set in accordance with the disposition, arrangement pitch, and height of the tip of each of the second connection terminal portions 11b of the lead blank 13 shown in FIG. 6.

After that, the base body 12 made of an insulating resin is molded while the lead blank 13 shown in FIG. 6 is inserted into the mold. In this case, insert molding is performed so that the lead blank 13 is embedded in the base body 12 except for the connection terminal portions 11a to 11c, wide portions 11e, and the connection parts 14 to 16 of the group of the connection terminals 11.

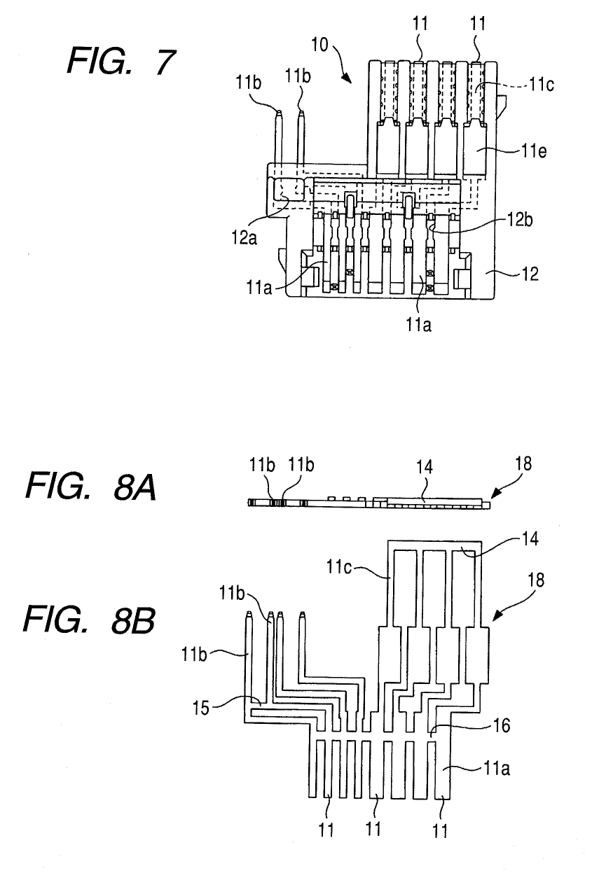

Then, the connection part 14 is cut off, a portion of the connection part 15 exposed to a through hole 12a of the base body 12 shown in FIG. 7 is cut off, and a portion of the connection part 16 exposed to a through hole 12b of the base body 12 is removed by blanking. Therefore, the connection terminals 11 are electrically isolated from each other. As a result, the lead block 10 (see FIGS. 2 and 7), where the total number of connection terminals 11 is seven and the three plated and pin-shaped second connection terminal portions 11b are arranged in two lines, is completed.

The first connection terminal portions 11a of the lead blocks 9 and 10 are connected to both ends (conductor parts) of the flexible cable 8 by ultrasonic welding and the second connection terminal portions 11c are connected to external leads, so that the lead blocks 9 and 10 manufactured as described above are mounted at predetermined positions on the stationary housing 1 and the movable housing 4. Further, the stationary housing 1 is fixed to a steering column of a steering device, and the movable housing 4 is fixed to a steering wheel. After mounting the rotary connector on the steering device in this way, it is possible to electrically connect the electrical device disposed on the steering column with the electrical device disposed on the steering wheel by inserting and connecting an external connector (female connector) to the group of the second connection terminal portions 11b of the lead blocks 9 and 10.

As described above, in the method of manufacturing the lead block for a rotary connector according to this embodiment, each of the lead blocks 9 and 10 has a compact shape. Accordingly, it is possible to easily manufacture the lead block and to easily improve the dimensional accuracy of the lead block. That is, the lead blank 13, which includes the group of the connection terminals 11 and the connection parts 14 to 16, is previously formed. The group of the connection terminals has a predetermined shape where the three pin-shaped second connection terminal portions 11b are arranged in two lines on parallel planes. The connection terminals are connected to each other by the connection parts 11. After the base body 12 is molded while the lead blank 13 is inserted into the mold, desired lead blocks 9 and 10 can be manufactured only by removing predetermined portions from the connection parts 14 to 16 by blanking. Accordingly, the dimensional accuracy of the lead blocks 9 and 10 is improved, so that it is possible to easily make the lead block compact. Further, since the number of processes is reduced, the number of parts is reduced as much as possible. As a result, it is possible to manufacture the lead blocks 9 and 10 at low cost.

Furthermore, in this embodiment, before the lead blank 13 is obtained by performing blanking on the metal plate 20, plating is performed on one side portion of the metal plate 20 and the group of the second connection terminal portions 11b connected to the external connector is formed using the plated portion. Accordingly, it is easy to improve the reliability of electric conduction between the external connector (female connector) or an external lead and the pin-shaped second connection terminal portion 11b. In addition, since the residual portions of the lead blank 13 are connected to the flexible cable 8 or the external lead by ultrasonic welding or are embedded in the base body 12, plating does not need to be performed on the residual portions. Therefore, unnecessary plating does not need to be performed, so that it is possible to reduce the cost of materials.

FIGS. 8 to 11 are views illustrating processes for manufacturing a lead block according to a second embodiment of the invention. Since portions corresponding to those of FIGS. 4 to 6 are indicated by the same reference numerals, the repeated descriptions thereof will be omitted. FIGS. 8A, 9A, and 10A are plan views, and FIGS. 8B, 9B, 10B, and 11 are front views.

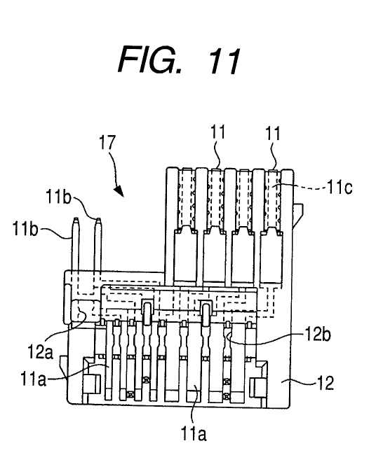

The second embodiment is different from the first embodiment in that a lead block 17 shown in FIG. 11 includes connection terminals 11 of which the total number is eight and four connection terminals 11 of the connection terminals have pin-shaped second connection terminal portions 11b connected to an external connector.

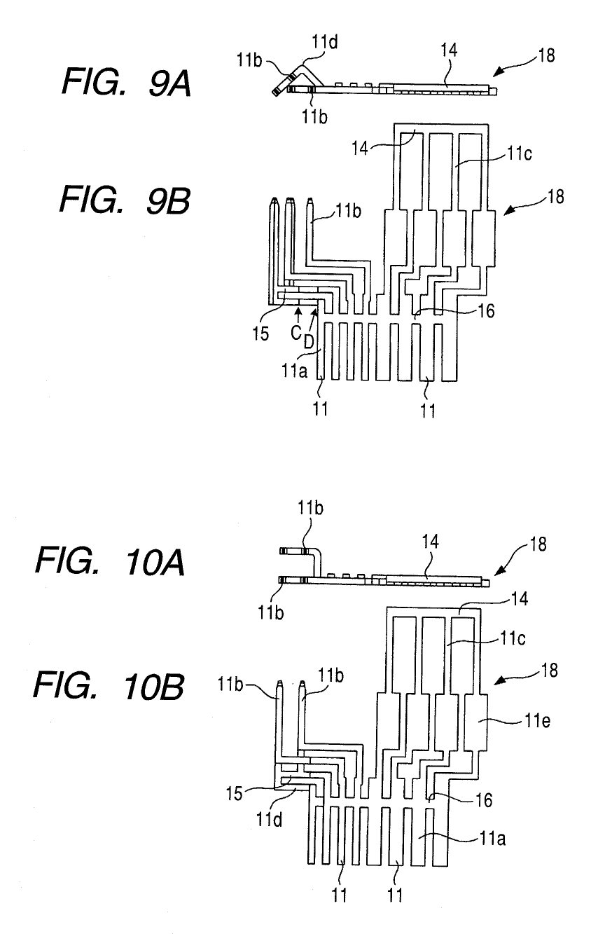

A method of manufacturing the lead block 17 is basically the same as the method according to the first embodiment. First, a lead blank 18, which has the shape of a substantially flat plate as shown in FIG. 8, is formed by performing blanking on a metal plate of which a part is plated. Further, as shown in FIG. 9, L-shaped portions 11d are formed by performing primary bending near a connection part 15 (at positions indicated in FIG. 9 by arrows C and D) on two connection terminals 11 that are shown on the left side of FIG. 9 and have connection terminal portions 11b. Further, as shown in FIG. 10, two second connection terminal portions 11b and the residual two second connection terminal portions 11b are arranged in two lines on parallel planes by secondary bending, and the lead blank 18 is formed in a three-dimensional shape. After that, a base body 12 made of an insulating resin is molded while the lead blank 18 shown in FIG. 10 is inserted into a mold. However, in this case, insert molding is performed so that the lead blank 18 is embedded in the base body 12 except for the connection terminal portions 11a to 11c, wide portions 11e, and the connection parts 14 to 16 of the group of the connection terminals 11. Then, the connection terminals 11 are electrically isolated from each other by removing the connection part 14 or a portion of the connection parts 15 and 16 exposed to through hole 12a and 12b of the base body 12 shown in FIG. 11. As a result, the lead block 17 (see FIG. 11), where the total number of connection terminals 11 is eight and the four plated and pin-shaped second connection terminal portions 11b are arranged in two lines on parallel planes, is completed.

Meanwhile, in the embodiments, a part of the group of the plurality of connection terminals 11 has been connected to an external connector and the other part thereof has been connected to an external lead. However, even though all of the plurality of connection terminal 11 may be connected to an external connector, it is possible to make a lead block compact by applying the invention. Further, it goes without saying that it is possible to improve dimensional accuracy and to reduce manufacturing cost with a small number of processes.

It should be understood by those skilled in the art that various modifications, combinations, sub-combinations and alterations may occur depending on design requirements and other factors insofar as they are within the scope of the appended claims of the equivalents thereof.

What is claimed is:

1. A method of manufacturing a lead block for a rotary connector that includes stationary and movable housings that are disposed concentrically with each other and connected to each other so as to freely rotate relative to each other, a flexible cable that is received in a space formed between the pair of housings so as to be wound and unwound, and lead blocks that are mounted at predetermined positions on the housings, the lead block being formed of a block where a plurality of connection terminals is held by an insulating base body, and a group of the connection terminals including first connection terminal portions connected to conductor parts of the flexible cable and second connection terminal portions connected to at least one of an external connector and an external lead, the method comprising:
forming a connection terminal connecting body, where the connection terminals are connected to each other by connection parts, by performing blanking and bending on a metal plate, the second connection terminal portions of the connection terminals being arranged on parallel planes;
forming a base body made of an insulating resin by performing insert molding so that the connection terminal connecting body is embedded in the base body except for at least of connection parts and the first and second connection terminal portions; and
making the connection terminals be electrically isolated from each other by removing predetermined portions of the connection parts.

2. The method according to claim 1,
wherein a part of the metal plate is plated before the blanking is performed, and the second connection terminal portions are formed using the plated portion.
